(19) United States
(12) Patent Application Publication
(10) Pub. No.: US 2015/0170088 A1
(43) Pub. Date: Jun. 18, 2015

(54) LOGIC FLOW GENERATOR SYSTEM AND METHOD

(71) Applicants: THE CLEVELAND CLINIC FOUNDATION, Cleveland, OH (US); iVHR, Inc., Cleveland, OH (US)

(72) Inventors: Wisam Rizk, Westlake, OH (US); Wael K. Barsoum, Bay Village, OH (US); Douglas R. Johnston, Shaker Hts., OH (US); Michael W. Kattan, Cleveland, OH (US); James J. Hribar, Eastlake, OH (US)

(21) Appl. No.: 14/573,487

(22) Filed: Dec. 17, 2014

Related U.S. Application Data
(60) Provisional application No. 61/917,123, filed on Dec. 17, 2013.

(51) Int. Cl. G06Q 10/06

(52) U.S. Cl. CPC G06Q 10/06316

(57) ABSTRACT

A system includes an interface to define one or more steps of a workflow, each step having at least one action to perform a task for an enterprise. The one or more steps of the workflow and the at least one action to perform the task are defined as an abstraction layer to select preprogrammed instruction code blocks to implement the action. A logic flow generator processes the workflow from the browser interface to generate a configuration file that defines executable actions representing the workflow from the selected instruction code blocks specified by the abstraction layer.

### CROSS-REFERENCE TO RELATED APPLICATION

This application claims the benefit of U.S. Provisional Patent Application 61/917,123 filed on Dec. 17, 2013, and entitled LOGIC FLOW GENERATOR SYSTEM AND METHOD, the entirety of which is incorporated by reference herein.

### TECHNICAL FIELD

This disclosure relates to a logic flow generator system and method.

### BACKGROUND

Various software tools are available to enable users to select functional blocks from a development library to build an underlying application. Such tools require a skilled software professional to implement new features of the given application. A programming tool or software development tool is a program or application that software developers use to create, debug, maintain, or otherwise support other programs and applications. This can include taking relatively simple programs such as library functions that can be combined together to accomplish a larger more complex task, much as one might use multiple tools to create a physical object. For many years, computer-assisted software engineering (CASE) tools were the preferred platform for development. In one sense, CASE tools emphasized design and architecture support and required sophisticated developers to utilize the tools. In the majority of modern development platforms, the most successful of these tools are referred to as Integrated Development Environments also known as IDE's. A common example of an IDE is the Visual development platform (e.g., Visual Basic, Visual C++) that is common in the desktop programming environment. In general, the IDE's combine the features of many tools into one package. For example, these tools make it easier to perform specific tasks, such as searching for content only in files in a particular project. The IDE's may for example be used for development of enterprise-level applications that can support various business operations.

Although IDE's enable skilled professionals to quickly develop new applications, they suffer from not being more broadly used by people who are not trained in software development. For example, if a business person needed a new application to serve a business need, they would have to propose their idea to a software developer to generate a new application. Moreover, the new application would have to be integrated with the existing system which often requires recompiling of the new application and/or the underlying system along with associated retesting to fully support the new application.

### SUMMARY

This disclosure relates to a logic flow generator system and method. In one aspect, a system includes an interface to connect and define one or more steps of a workflow. Each step has at least one action to perform a task for an enterprise. The one or more steps of the workflow and the at least one action to perform the task are defined as an abstraction layer to select preprogrammed instruction code blocks to implement the action. A logic flow generator processes the workflow from the interface to generate a configuration file that defines executable actions representing the workflow from the selected instruction code blocks specified by the abstraction layer.

In another aspect, a method includes selecting one or more steps from a library in response to a user input. This includes selecting one or more actions for each step in response to another user input. The one or more steps and the one or more actions are defined as an abstraction layer to select executable instruction code blocks to implement the action. The method includes connecting each step to form a workflow for an enterprise in response to a user input. Each connection specifies a source action and a destination action to traverse in the workflow. The method includes generating a configuration file representing the workflow. The configuration file defines an abstraction layer for the arrangement of actions.

In yet another aspect, a system includes a configuration file that defines a sequence of discrete executable actions and associated connections between each pair of sequential actions to represent an ordered workflow. The workflow includes one or more steps. Each step includes at least one action to perform a task for an enterprise. The one or more steps of the workflow and the at least one action to perform the task are defined in an abstraction layer to select preprogrammed instruction code blocks to implement each action. An execution engine interprets the workflow provided by the configuration file to perform the task for the enterprise by invoking each of the selected code blocks identified in the abstraction layer and in an ordered sequence represented by the workflow.

### BRIEF DESCRIPTION OF THE DRAWINGS

FIG. 1 illustrates an example of a system that employs a logic flow generator to generate workflows that can be executed to perform automated tasks.

FIG. 2 illustrates an execution engine for executing a configuration file generated by the system of FIG. 1.

FIG. 3 illustrates an example step structure for a logic flow step for a configuration file that can be defined as part of a browser-based interface.

FIG. 4 illustrates an example configuration file that can be generated by a logic flow generator.

FIGS. 5 and 6 illustrate alternative interface examples for a workflow having various steps and connections.

FIG. 7 illustrates an example method for generating workflows that perform automated tasks for an enterprise.

FIG. 8 illustrates an example workflow application for an enterprise utilizing a logic flow generator and interface.

FIG. 9 illustrates an example hierarchy for organizing questions and groups from the example workflow depicted in FIG. 8.

FIG. 10 illustrates an example execution workflow based off the hierarchy example of FIG. 9.

FIG. 11 illustrates an example system that utilizes an abstraction layer to select instruction code blocks to perform a workflow task.

FIG. 12 illustrates an example interface for editing a step in a workflow.

FIG. 13 illustrates an example interface for editing a connection in a workflow.

FIG. 14 illustrates an example interface for configuring a code action in a workflow step.

FIG. 15 illustrates an example interface for configuring a database action in a workflow step.

FIG. 16 illustrates an example interface for configuring a URL action in a workflow step.

FIG. 17 illustrates an example interface for configuring a web request action in a workflow step.

FIG. 18 illustrates an example interface for configuring an e-mail action in a workflow step.

FIG. 19 illustrates an example interface output when running a workflow.

FIG. 20 illustrates an example interface output when testing a workflow.

### DETAILED DESCRIPTION

This disclosure relates to a logic flow generator system and method. For example, a system and method can provide a browser-based tool for new code modules that can be developed in a business environment without modifying the underlying execution environment. Thus, the systems and methods disclosed herein can be used for application development by various members of an enterprise such as a business. A logic flow generator can access a library that includes pre-configured actions to enable enterprise tasks to be efficiently specified and developed from a graphical user interface (e.g., a browser-based interface), which can be utilized by various members across the enterprise. The pre-configured actions can be assigned to logic flow steps of the interface that represent portions of an enterprise workflow which can be interconnected by browser graphical connections, such as an arrow (e.g., a directed arc) corresponding to logical connectivity from one action to a next action. For instance, a given connector can define which target step to follow next and/or include logic (e.g., a conditional expression) to implement as part of a decision-branch connection to invoke one or more subsequent target steps of the workflow. A configuration file thus can be generated to define a given workflow, including each of the pre-configured actions as well as logical connectivity between such actions. By connecting the steps on the browser-based interface to define a given workflow, users can configure enterprise workflows to perform various enterprise tasks in an abstract manner without having to understand the underlying code to perform the actions selected in the steps and without having to compile an application for execution of the workflow.

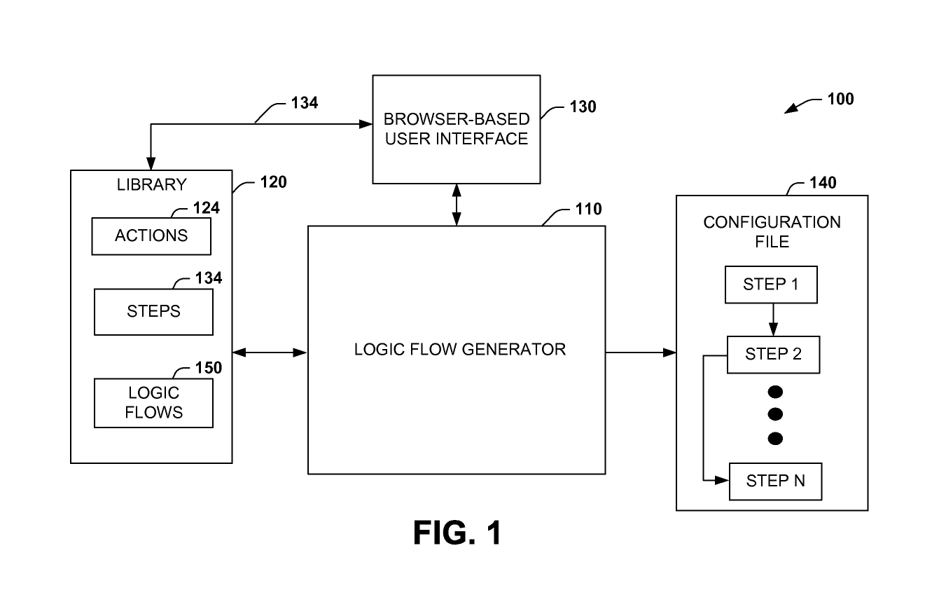

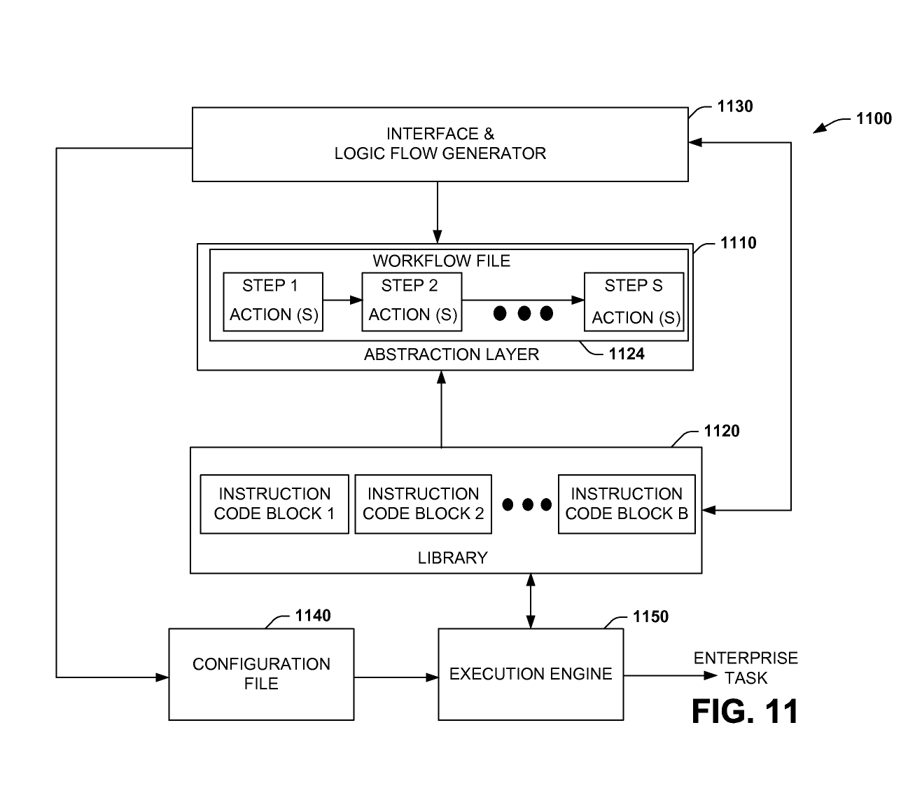

FIG. 1 illustrates an example of a system 100 that employs a logic flow generator 110 to generate browser-based workflows that perform automated tasks for an enterprise. As used herein, the term logic flow refers to at least one logic step that performs one or more actions such as can correspond to a pre-programmed computer-executable code block (e.g., already compiled code or another workflow to perform a defined function or group of functions). A logic flow can be a subset of actions in a larger workflow to perform a task or tasks for an enterprise. In some examples, the logic flow and the workflow can be the same. As used herein, the term action refers to a task that can be performed by a given enterprise or business yet is defined as an abstraction (e.g., in an abstraction layer) over the underlying instructions or computer languages that implement the action. Examples of actions can include gathering data from a resource, generating and populating a questionnaire, performing a database action, scoring answers to questions, generating or sending an e-mail, ordering supplies, executing custom code module, generating a lab request, scheduling an appointment, and so forth. An example system is illustrated and described below with respect to FIG. 11 showing how actions can be defined as a combination of steps that define a workflow at an abstraction layer of the system. The abstraction layer can be utilized to help users specify tasks to be performed without having to understand complex computer languages to implement the tasks.

A workflow can be considered a combination of steps and/or other pre-configured logic flows that are interconnected to perform an overall task. In some examples the task can include an application specific task for an enterprise. The logic flow generator 110 receives input from a library 120 (or libraries) that includes pre-configured executable actions 124 to enable enterprise tasks to be efficiently specified and developed from a browser-based interface 130 (also referred to as interface 130). In some examples, the interface 130 can be utilized by various users across the enterprise to create and/or edit one or more logic flows.

The interface 130 can access the library 120 as part of an internal network connection and/or via a public network connection. The pre-configured actions 124 can be assigned to logic flow steps via the interface 130 that represent portions of an enterprise workflow. Each step can be interconnected by interface graphical connections such as an arrow representing which step to follow next. In one example, an action can be selected from the interface 130 and dragged onto a work screen of the interface where a step is automatically generated on the screen with the selected action configured therein. In another example, a non-configured step can be dragged onto the work screen of the interface 130 where an action can subsequently (e.g., dragged onto step from action library) be added to the non-configured step.

In another example decision-branch connections that can connect to one or more other steps of the workflow based on the results of conditional expressions. The conditional expressions can be based on actions performed in one or more preceding steps for example and/or be based on other data that may be available to the device (e.g., computer) executing the logic flow. By connecting the steps on interface 130 to define a given workflow, users can configure enterprise workflows to perform various enterprise tasks in an abstract manner without having to understand the underlying code to perform the actions selected in the steps and without having to compile an application source code for execution of the workflow.

The logic flow generator 110 receives commands from the interface 130 regarding which actions 124 to employ from the library 120 as part of given step. For example, the user can define a step 134 from the library 120 (e.g., graphical output block representing step appearing on interface) having one or more actions 124. Parameters can be defined for configuring the respective actions selected for each respective step 134. Similarly, the user can define other steps and connect the steps with arrows linking a source step with the next step in the workflow to follow. The connector can also be programmed to define a conditional expression which can indicate logic to be implemented on available data before traversing to the next step for executing the corresponding action defined by such next step. As disclosed herein, a condition defined for a connector can include a conditional expression (e.g., Boolean logic, comparisons or the like) that depends on feedback received and/or data collected during execution of the workflow.

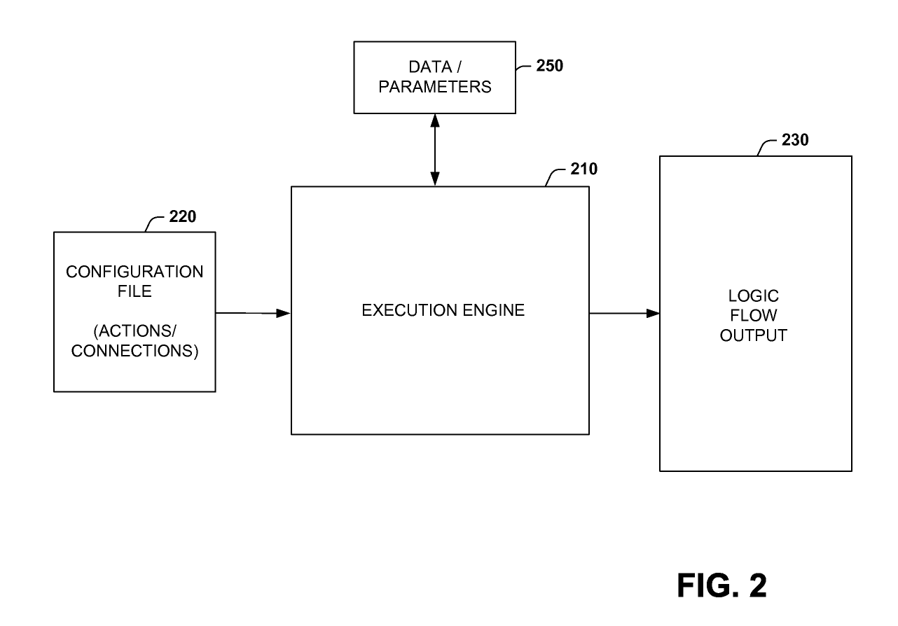

After the steps and connections between the steps are selected via the interface 130, the logic flow generator 110 generates a configuration file 140 that includes an arrangement of one or more steps shown as steps 1-N, with N being a positive integer. The configuration file 140 also includes a listing of connections that defines how each of the steps is connected to one or more next step as well as logic (if any) to implement to traverse each such connection. After the configuration file 140 is generated by the logic flow generator 110, an execution engine (See FIG. 2) may execute the configuration file 140 to perform the workflow tasks defined in the configuration file. The configuration file 140 can include one or more steps with each step in the file including one or more actions 124 as well as the parameters defined for each respective action.

As shown in this example, the library 120 can include other logic flows 150 that represent previously defined configurations of steps, which include actions and connections between steps, such as can be stored in memory, such as in response to a user input and/or provided as set of predefined logic flows. Thus, new workflows can be developed by implementing a step as including one or more previously defined logic flows 150, which can be connected another step of the new workflow. The library 120 can also include other code modules that can represent custom code developed for the library and selected for use in the workflow. The code modules can be written in substantially any programming language. A code module may be executed directly in the configuration file 140 and/or executed as part of a call (e.g., via label or tag) to the code module as defined in the configuration file as an action of a corresponding step. Additionally, the library 120 can include other libraries that represent other actions 124, steps 134, and logic flows 150 for differing functions and tasks across the organization. For example, other libraries could be a form processing library, a scheduling library, an order library, a medical procedure library, a lab processing library, a business development library, and so forth.

FIG. 2 illustrates an execution engine 210 for executing a configuration file 220 generated by the system of FIG. 1. As noted previously, the configuration file 220 includes data describing one or more steps, each step having one or more actions, and each step can be connected via defined connections (e.g., sequential and/or conditional logic) to describe a given workflow of an enterprise (e.g., hospital or business) or the like. The execution engine 210 interprets the configuration file 220 to generate an executable logic flow output 230. The executable actions implemented in the logic flow 230 can stored in substantially any programming language (e.g., SQL, JAVA, C++, C#, and so forth). For example, the execution engine 220 can interpret the steps, actions, and connections in the configuration file 220 and execute or cause to be executed various actions at each step provided in the configuration file. Additionally, the execution engine 210 can traverse from one step to next according to logic defined by an associated connector as described in the configuration file. For example, each connector can include a start ID for a source action and one or more destination IDs for each subsequent action. Additionally, as mentioned, a given connection can define logic and parameters for an expression to control traversal from the source to the one or more destination actions in the logic flow. As shown, the execution engine 210 can retrieve data and/or parameters 250 to support execution of the configuration file 220.

The configuration file 220 can be defined according to a programming language or schema, such as can be a collection of well-defined language commands, for example, that are interpreted by the execution engine 220. The execution engine 220 traverses the configuration file to implement the specified actions at each step according to the specified parameters in the configuration file 220. The execution engine 220 can further access computer-executable code, corresponding to the specified actions, as the executable logic flow 230 is executed. The execution engine can also access system data associated with the enterprise in which the logic flow is being executed. The data can be used to compute logical expression in connectors as well as to provide input parameters/data and receive output parameters/data for other actions defined for each action in the configuration file. The execution engine 220 can be a JAVA virtual machine or SQL command line interpreter, and/or can be constructed as custom-code (e.g., complied application engine) that outputs the executable logic flow 230 based on received commands from the configuration file 230.

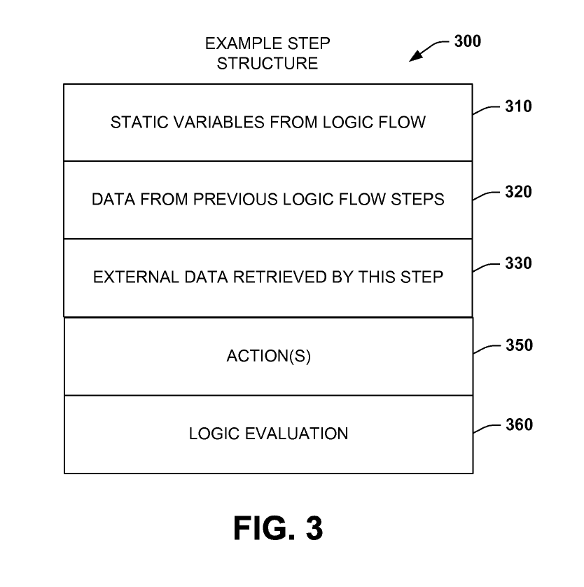

FIG. 3 illustrates an example step structure 300 for a logic flow step for a configuration file that can be defined in response to user inputs using logic flow generator (110 of FIG. 1). The step structure 300 includes static variables 310 are updateable and can be used across a logic flow or workflow. At 320, the step structure 300 can include data accumulated from previous steps, which can be stored in memory and be made available to actions in the currently executed step, a conditional connection between steps and/or passed on to another step. At 330, the step structure 300 can include external data retrieved by this step. This can include new data retrieved by action calls and/or custom calls. User-entered data from a given workflow is typically held at this location. At 350, the step structure 300 can include one or more actions. For example, the actions can include surveys, e-mails, web services, other logic flow functions, scoring functions, predictive algorithms, and a plurality of other predefined actions, for example, which executable compiled code can be stored in memory that is accessible by each execution engine. At 350, the step structure 300 can include evaluation logic for evaluating the information collected by this step.

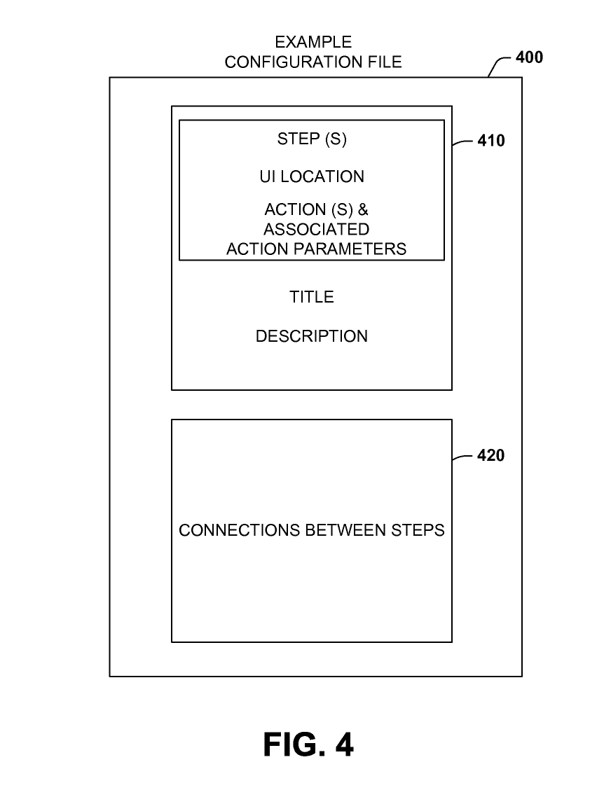

FIG. 4 illustrates an example configuration file 400 that can be generated by a logic flow generator described above with respect to FIG. 1. The configuration file 400 includes one or more steps 410. Each step 410 can include can include one or more defined actions with each action potentially having one or more input and/or output parameters. The step 410 can also include data relating to its user interface location defining where the step appears on an output screen of the interface. The step 410 can include a color definition describing the color of the step as it appears on the interface. The step 410 can also include a text description describing the function of the step to assist the user selection of a given step. The configuration file 400 can also include connections 420 that describe how steps are connected to each other in a given logic flow and/or workflow. The steps can include a source ID showing where the step begins, a destination ID showing where the next step is, and a logic expression that can include input and output parameters for execution of the action in the given step.

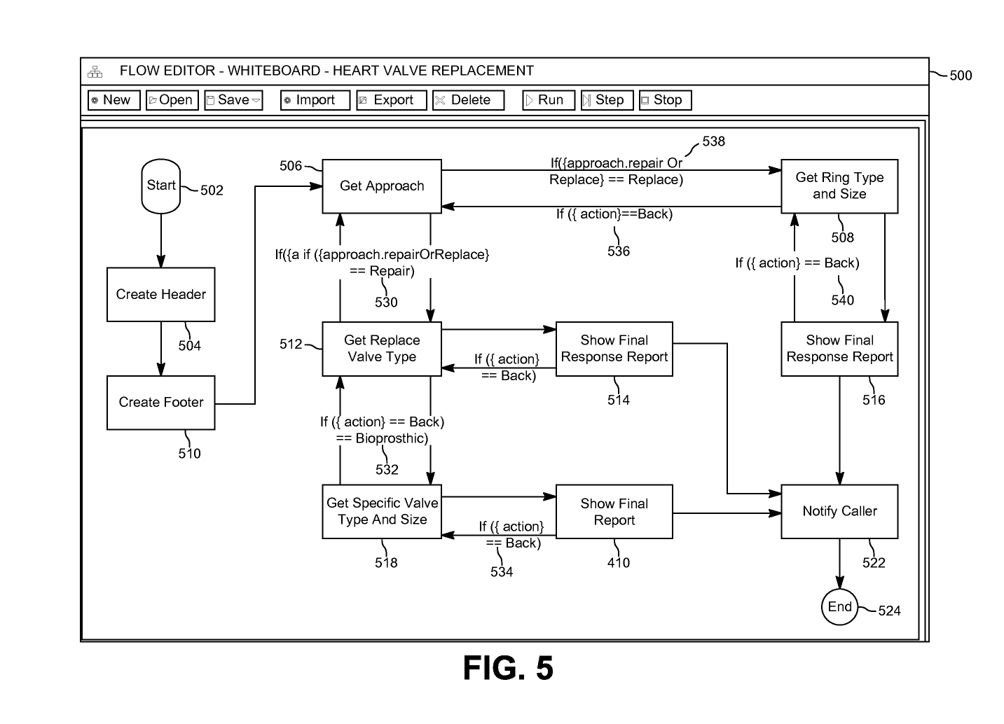

FIG. 5 illustrates an example interface display 500 demonstrating a corresponding logic flow that includes a plurality of steps and connections. Example steps include a start step 502, a create header step 504, a get approach step 506, a get ring type step 508, and a create footer step 510. Other example steps include a get replace value step 512, a show final response report step 514 a show final response report step 516, a get specific value type and size step 518, a show final response report step 520, a notify caller step 522, and an end step 524. Steps can be connected via directed paths (e.g., represented as arrows) defining an always true next action and/or connected via programmable decision logic statements to determine whether execution advance to from a source step to a specified target step. Example decision blocks are shown as logic connections at 530, 532, 534, 536, and 538.

For example, for the step defining “get approach” at 506, the configuration file is generated as:

“steps”: [{

“id”: “step_523322243”,
“title”: “Get Approach”,
“top”: “52.3125px”,
“left”: “357.328125px”,
“cls”: “w”,
“description”: “”,
“actions”: [{

“parameters”: [{

“key”: “model”,
“value”: “”

}, {
“key”: “view”,
“value”: “@{ this.WriteLiteral(@ViewBag.header);

}\n\n<table>\n\t<thead>\n\t\t<tr>\n\t\t <th
colspan=\“2\”>Approach</th>\n\t\t</tr>\n\t</thead>\n\t<tbody>\n\t<tr
class=\“row\”>\n\t\t<td width=\“300px\”>\n\t\t\tWhat is the
approach?\n\t\t</td>\n\t\t<td>\n\t\t\t<select name=\“approach\”>\n\t\t\t <option>Not
Specified</option>\n\t\t\t <option value=\“Left Atriotomy\”>Left Atriotomy</option>\n\t\t\t
<option value=\“Transeptal\”>Transeptal</option>\n\t\t\t <option value=\“Extended
Transeptal\”>Extended Transeptal</option>\n\t\t\t</select>\n\t\t</td>\n\t</tr>\n\t<tr
class=\“row-alt\”>\n\t\t<td width=\“300px\”>\n\t\t\tAre you repairing or replacing the
valve?\n\t\t</td>\n\t\t<td>\n\t\t\t<select name=\“repairOrReplace\”>\n\t\t\t <option>Not
Specified</option>\n\t\t\t <option value=\“Repair\”>Repair</option>\n\t\t\t <option
value=\“Replace\”>Replace</option>\n\t\t\t</select>\n\t\t</td>\n\t</tr>\n\t</tbody>\n</tab
le>\n\n@{ this.WriteLiteral(@ViewBag.footer); }”

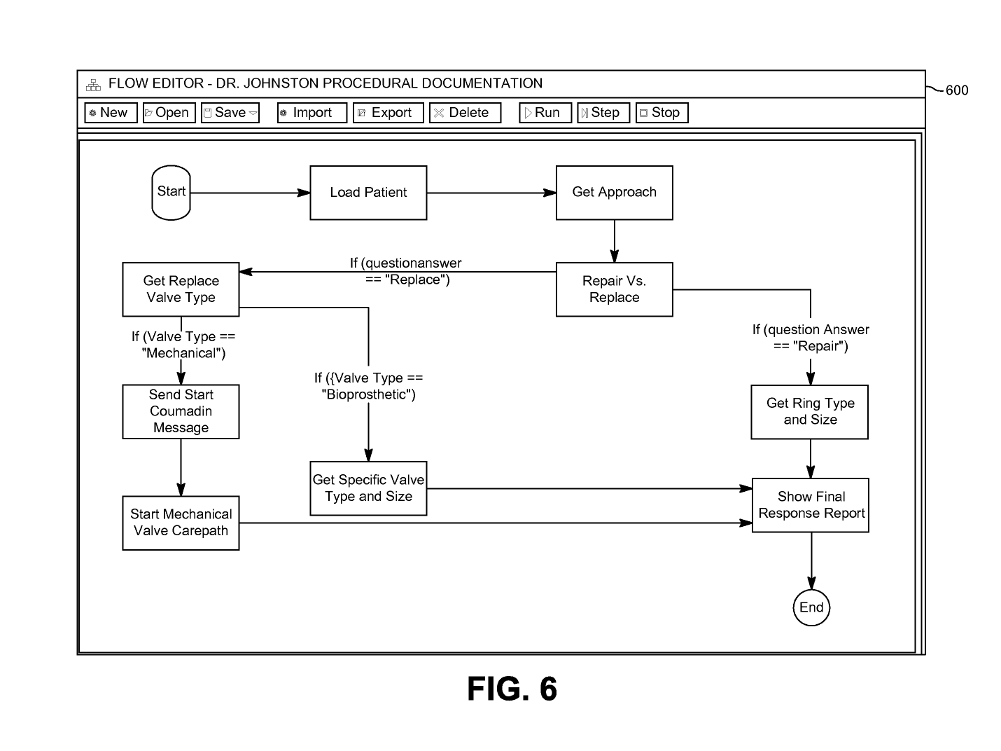

After the steps, actions, and parameters are generated in the configuration file 400, connections between each step at 420 can then be generated and stored as part of the configuration file. An interface 600 is provided as an alternative example in FIG. 6 for a workflow having various steps and connections associated with an approach to repair or replace a heart valve. The following shows an example connection delaration in an example configuration file:

“connections”: [{

“id”: “con_7”,
“sourceId”: “step_5233222442”,
“targetId”: “step_5233222446”,
“variable1”: “{valve.type}”,
“comparison”: “==”,
“variable2”: “Bioprosthetic”

}, {

“id”: “con_13”,
“sourceId”: “step_52332224222422”,
“targetId”: “end”,
“variable1”: “−1”,
“comparison”: “==”,
“variable2”: “−1”

}, {

“id”: “con_34”,
“sourceId”: “step_523322243”,
“targetId”: “step_5233222443”,
“variable1”: “{approach.repairOrReplace}”,
“comparison”: “==”,
“variable2”: “Replace”

}

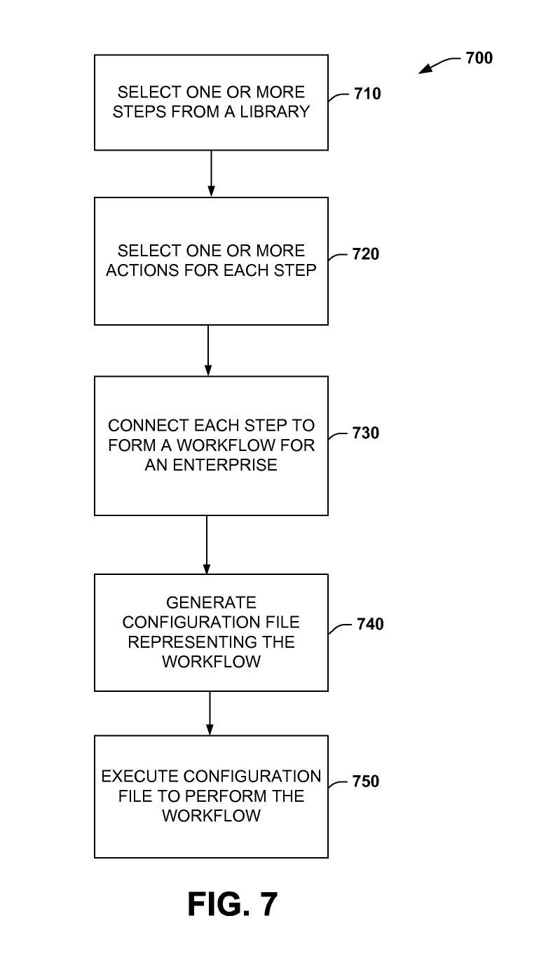

In view of the foregoing structural and functional features described above, an example method will be better appreciated with reference to FIG. 7. While, for purposes of simplicity of explanation, the method is shown and described as executing serially, it is to be understood and appreciated that the methods are not limited by the illustrated order, as parts of the method could occur in different orders and/or concurrently from that shown and described herein. Such method can be executed by various components configured as executable instructions stored in a computer memory (e.g., one or more non-transitory computer readable media) and executed by a processor, for example.

FIG. 7 illustrates an example method 700 for generating a logic flow that includes actions and connections that can be executed (e.g., by execution engine 210 of FIG. 2) to perform automated tasks for an enterprise. At 710, the method 700 includes selecting one or more steps from a library (e.g., via interface 130 and library 120 of FIG. 1). For example a default step can be an empty step. In other examples, a predefined step can be selected. At 720, the method 700 includes selecting one or more actions for each step (e.g., via interface 130 and library 120 of FIG. 1). The one or more steps and its one or more actions can be defined as an abstraction layer that identify one or more preprogrammed executable code blocks to implement the action. As mentioned, the actions at a given step can be selected from a library, such as can include execution of custom code, loading data from a predetermined resource, displaying a graphical output, redirecting to a resource (e.g., a web page) or calling a web service. At 730, the method 700 includes connecting each action to form a logic flow for an enterprise (e.g., via interface 130 of FIG. 1). At 740, the method 700 includes generating a configuration file representing the workflow (e.g., via logic flow generator 110 of FIG. 1). At 750, the method 700 can include interpreting the configuration file to execute and the corresponding the workflow (e.g., via execution engine 210 FIG. 2). Execution of a workflow can be performed by an execution engine accessing each executable code block according to input parameters specified for the action, such as by a function call and returning any outputs back to the execution, which can be stored in memory and used by subsequent blocks of the logic flow.

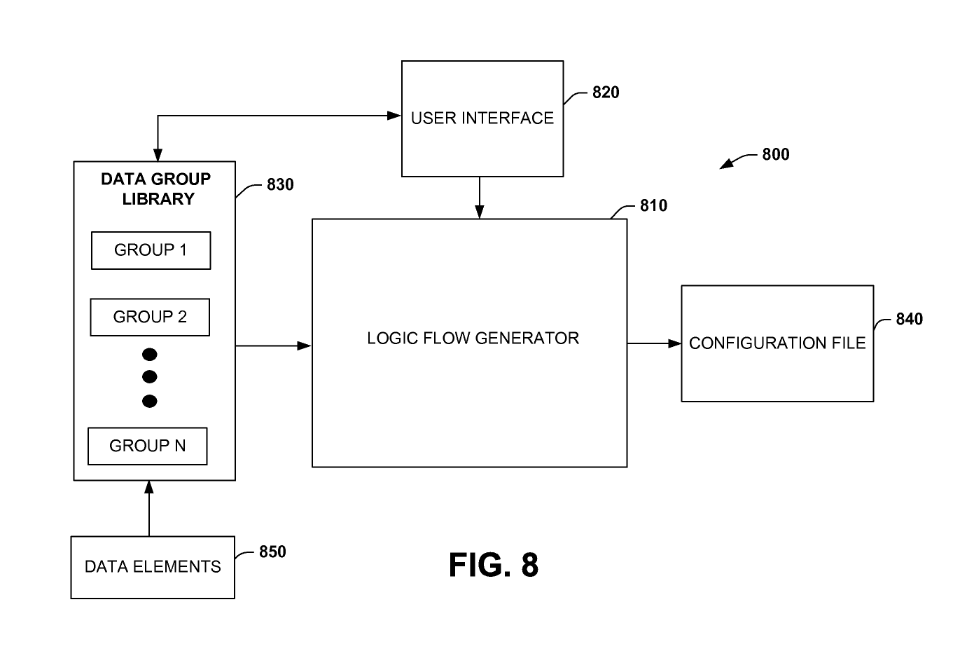

FIG. 8 illustrates an example workflow application for an enterprise utilizing a logic flow generator 810 and user interface 820. In this example, a library 830 of data groups, shown as groups 1 through N, is processed by the logic flow generator 810 to generate a configuration file 840 representing various one or more logic flows to be processed for a plurality of related enterprise groups. For example, the groups can represent a plurality of various questions or groups of questions (e.g., forms or templates) that may be processed by users of an enterprise (e.g., healthcare enterprise). Each group can be populated by one or more data elements 850 representing questions related to patient and/or institutional concerns, such as can be implemented as part of a patient intake process.

In this example, the data elements 850 can be composed of questions whereas the groups can define sets of questions. The logic flow generator 810 can then define workflows to route and process question groups based on the context encountered during execution of a workflow. Actions in one or more steps of such workflow can also interact with a database or other resources to acquire information that can be automatically utilized to populate one or more data fields, such as for patient information, vitals, demographic information, that may have been entered previously.

The system 800 for generating an enterprise questionnaire thus provides a versatile content management system, data integration mechanism, and business logic processor on multiple levels of the enterprise while mitigating the need for advanced software knowledge by any individual of the enterprise. For example, a logic flow can be created to obtain a set of global information required by the enterprise and different groups within the enterprise can employ another logic flow to obtain information specific to each group and individual users can further employ further logic flows to obtain information specific each such individual's role in the enterprise. One or more of these different levels of enterprises can be implemented as different steps of a composite logic flow configured to obtain the requisite intake information through each level of the enterprise according to the user's context. The logic flow further can be configured to remove duplicate questions from among the steps and still provide complete data sets for each level. These components can provide a questionnaire to the patient or provider and assist in patient data collection and provider-based documentation, for example.

As a further example, the questions can be stored in the library 830 as a store of individual discrete questions built and referenced in multiple Question Groups, for example. Each question is unique across the system, and can be used in any number of enterprise groups. This allows for easy manageability across groups and within the system. The Question Group is a store containing groupings of questions. Within a Question Group, any number of questions can be inserted together with branching logic defined for the specific group. Each group of questions can be short or as long as necessary for a given enterprise purpose. The logic flow generator 810 and interface 820 enables business rules to be developed that allows the presentation of Question Groups based on defined business rules in a workflow paradigm. The rules can be simple or complex (e.g., nested decisions and logic). Further, the logic flow generator 810 can select other logic flows, allowing for a highly reusable architecture across the enterprise. Thus, the selected steps in a logic flow provide the ability to perform actions including the execution of Web services, production of messages, processing of messages, emails and implementation of custom blocks of C# code or other programming languages, for example, if customization is needed.

As opposed to a classical questionnaire approach based on single monolithic surveys, questions and question groups can be de-linked via the workflow. Flexible linkages are created based on the defined logic flows within an overall workflow. This transformation allows for an effective management solution, enables complex decision making around Question Groups, and provides the effective clinical reporting that is necessary for any enterprise. As new regulatory requirements are imposed and new tools become available, this approach eliminates the need to write new logic as it resides outside the EMR, allowing a more flexible response to change. Instead, different actions, each corresponding to a given question or question group (e.g., a logic flow itself), can be swapped with other actions (different questions) to update a given questionnaire that defined by given configuration file. As a result, modifications and expenses are minimized. In addition, the creation of substantially any type of question grouping is possible by editing the logic flow to provide an updated configuration file.

In the event a system is organized as a set of components tied to an organizational structure, the effectiveness and differentiation of forms processing becomes more prevalent. Therefore, the workflows described herein allow the organization of patient intake based on Question Groups as well as the organizational structure combined with workflow and clinical intelligence, for example. Thus, questions and Question Groups can provide the backbone and content of intake and form processing. The creation of questions and Question Groups is the first step in the system and can be done through the user interface 820. Questions can be organized within libraries for ease of management. For example, one could create a wellness library and an orthopedic library, for example. Libraries can be used to make question management simpler and more effective. Question Groups are created to group questions together logically, such as to provide Question groups for each logic grouping within the enterprise. For example, a clinic could designate a standard set of questions that it would like in every questionnaire including demographic information and other cross-institute items. In addition, Question Groups can contain metadata that allows for the creation of header and footer information, for example.

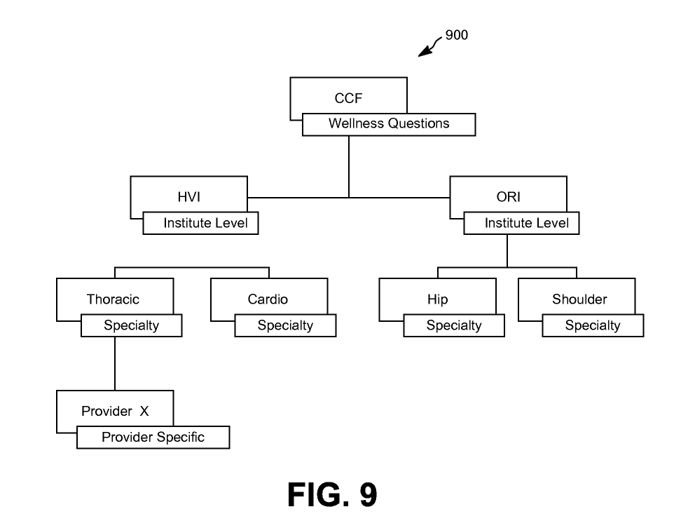

FIG. 9 illustrates an example hierarchy 900 that can be utilized for organizing questions and groups of questions from the example depicted in FIG. 8. In this example hierarchy, each block can represent a logic flow that includes an ordered arrangement of questions/actions that are linked together in ordered by associated connectors and which connectors can include logical expressions, such as disclosed herein. Each logic flow further can be grouped together as another level of logic flow via corresponding connectors. In order to manage enterprise patient data collection, it is generally necessary to perform an analysis across several levels of the enterprise to ensure discrete definition of questions across the enterprise. This will enable users to manage different question groups on different levels, independently of each other. For example, the question group hierarchy 900 may be created.

The hierarchy of information can executed using logic flow configuration files which wrap business rules around Question Groups, for example. One of the largest issue enterprises face today is the replication of information and data that should be standardized across the enterprise. In turn, reporting on the data not only becomes an immense challenge but it becomes extremely costly. This problem is solved by separating the questionnaire from a single monolithic object into a simple questions group-based paradigm, placed together with business rules defined by the steps, actions, and connections of a workflow constructed by a logic flow generator as disclosed herein.

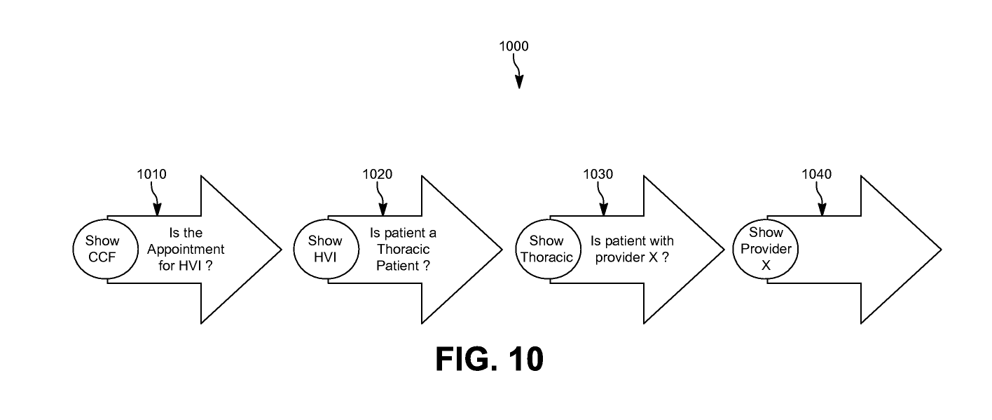

FIG. 10 illustrates an example execution workflow 1000 based off the hierarchy example of FIG. 9. In the above example 900, on each level, a group or potential groups of questions might be created and served up based on business rules within the workflow. As shown, an answer to a first question at 1010 may bring up an HVI (heart and vascular institute) or some other institute's questionnaire at 1020. An answer at 1020 indicating thoracic may bring up a thoracic questionnaire at 1030, where a questionnaire for provider X is shown at 1040. Each questionnaire can itself be implemented as a respective logic flow. This structure allows a separation of the questions required by each hospital, institute, specialty group, and provider, for example. These divisions enable the separate management of individual questions and Question Groups at each respective organizational level. For example, this structure allows the creation of steering committees that can then manage their particular set of questions. For instance, a global committee of a healthcare enterprise might create its own group of 30 questions, while another institute or subset of the enterprise (e.g., HVI) can have its own question group that includes a predetermined set of questions. If the enterprise wants to make a change to its global set of questions, the workflow enables the alteration without impacting any of the questions or groups implemented by the respective logic flows. The defined logic flows can be used as small short rule sets that deliver specific question groups to any type of users, or they can be used to manage the entire data collection workflow within the enterprise.

FIG. 11 illustrates an example system 1100 that utilizes an abstraction layer 1110 to select instruction code blocks from a library 1120 to perform a workflow task. The workflow task can be specified as a workflow file 1124 having one or more steps one through S, with S being a positive integer. Each step includes at least one action to perform a task for an enterprise, wherein the one or more steps of the workflow file 1124 and the at least one action to perform the task are defined in the abstraction layer 1110 to select instruction code blocks one through B, with B being a positive integer, to implement the action. An interface and logic flow generator 1130 can be provided to facilitate creation and generation of the workflow file 1124 in the abstraction layer 1110.

As noted previously, the term action refers to a task that can be performed by a given enterprise or business yet is defined as an abstraction in the abstraction layer 1124 which selects the underlying instructions or computer languages that implement the action from the instruction code blocks of the library 1130. Examples of actions can include executing one or more block of compiled code or custom code for: gathering data from a resource, generating and populating a questionnaire, performing a database action, scoring answers to questions, generating an e-mail, ordering supplies, executing custom code module, generating a lab request, scheduling an appointment, and so forth. A configuration file 1140 defines executable actions representing the workflow file from the selected instruction code blocks of the abstraction layer 1124. An execution engine 1150 interprets each of the actions and connections between pairs of actions, as defined in the configuration file, to perform the task for the enterprise from the selected code blocks of the abstraction layer. As shown, the execution engine also has access to the library 1120 to retrieve instruction code blocks for execution as specified by the configuration file 1140. In some examples, the configuration file 1140 itself can include executable code blocks. In other examples, the configuration file 1140 can include an identifier or link that is interpreted by the execution engine 1150 to retrieve an instruction code block for execution from the library 1120 to perform an enterprise task.

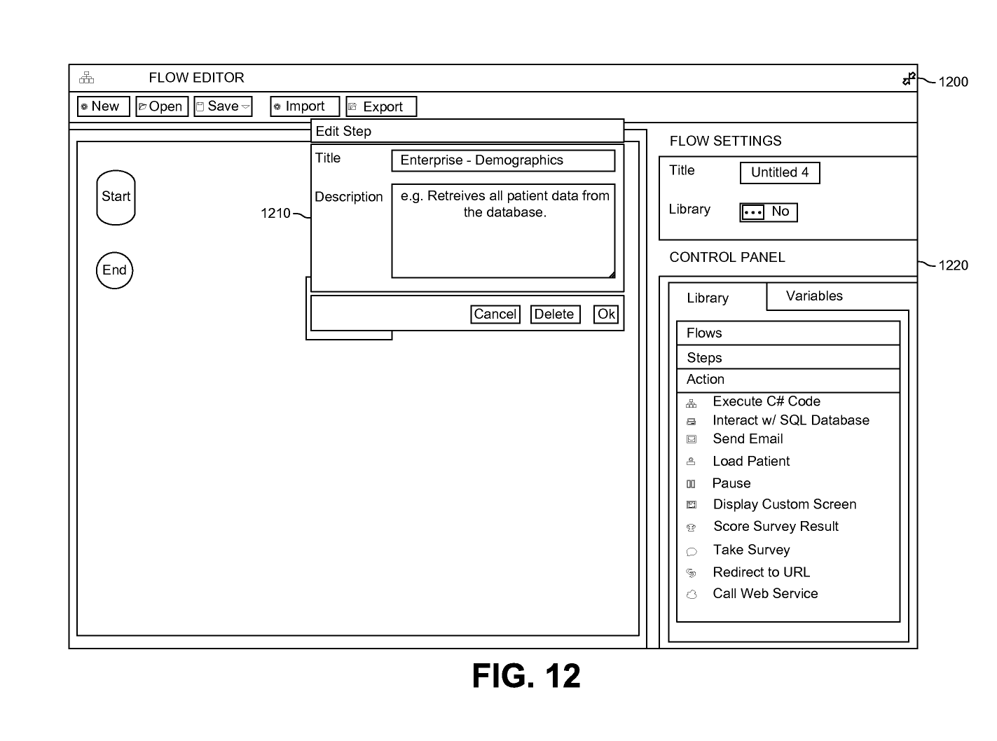

FIGS. 12-20 represent example interface displays that can be employed with the logic flow systems and methods described herein. Each interface depicted in FIGS. 12-20 can be provided via a graphical user interface (e.g., interface 130 shown in FIG. 1), wherein a configuration file (e.g., configuration file 140 of FIG. 1) representing the steps, actions, and connections of the interfaces can be generated via a logic flow generator (e.g., logic flow generator 110 of FIG. 1). The format of a given visualization further can vary depending on the type of the display and device on which the visualization is presented as part of the logic flow execution. After a configuration file has been generated, an execution engine (e.g., execution engine 210 of FIG. 2) can execute the configuration file to perform the steps and actions defined for the workflow. Also, in some cases, intermediate execution of a workflow can be displayed by the logic flow generator as will be illustrated and described below.

FIG. 12 illustrates an example interface 1200 for editing a step in a workflow. The interface 1200 includes an edit step box 1210 that includes programmable fields for naming and describing a step. A control panel 1220 includes actions and variables that can be defined, in response to a user input (e.g., dragging and dropping a selected action, for the step including execute custom code, database actions, sending an e-mail, loading patient data, pausing, displaying custom screens, scoring survey results, redirecting to a URL, and calling a web service, for example.

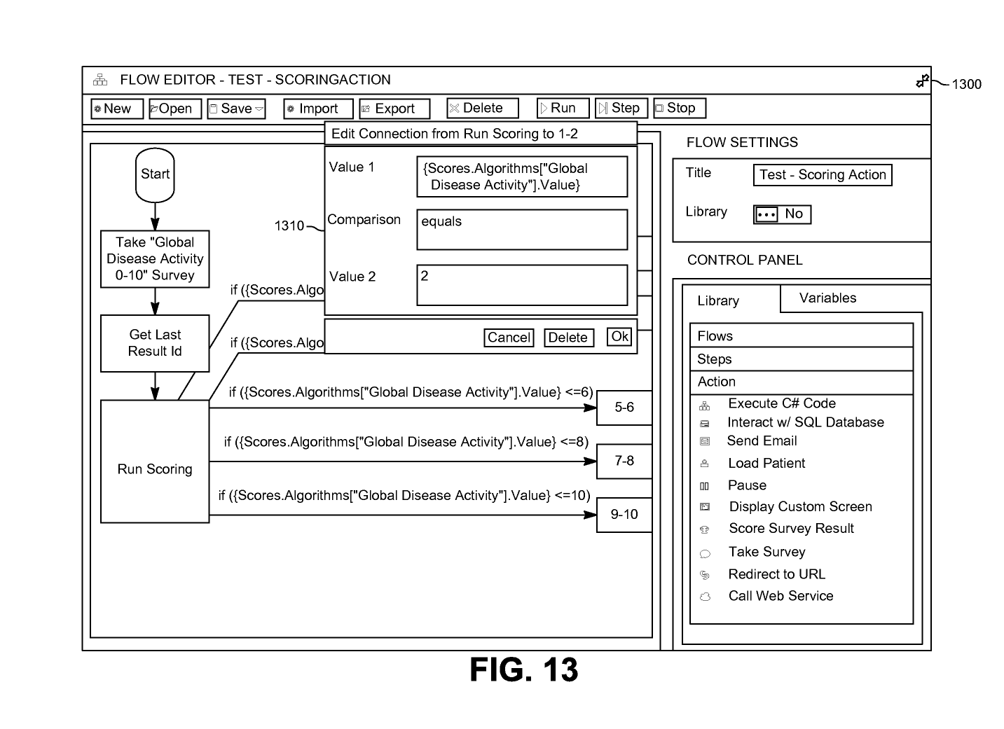

FIG. 13 illustrates an example interface 1300 for editing a connection in a workflow. The interface 1300 includes an edit connection box 1310 when a given connection is selected for a workflow. The connection box 1310 can includes at least one values box and a comparison box that defines an expression to compute as a function of the specified values and thereby control conditions in response to which the logic flow can transition from the present step enters a subsequent step defined by such connector. For example, the expression can be a constant (e.g., always true) expression causing the next step to proceed without delay. In other examples, a constant value can be defined to implement a predetermined pause of time before moving to the next step/action. As yet another example, the expression can be defined as a conditional statement including mathematical and/or logical operators setting the conditions precedent to control proceeding to one next step or to another next step.

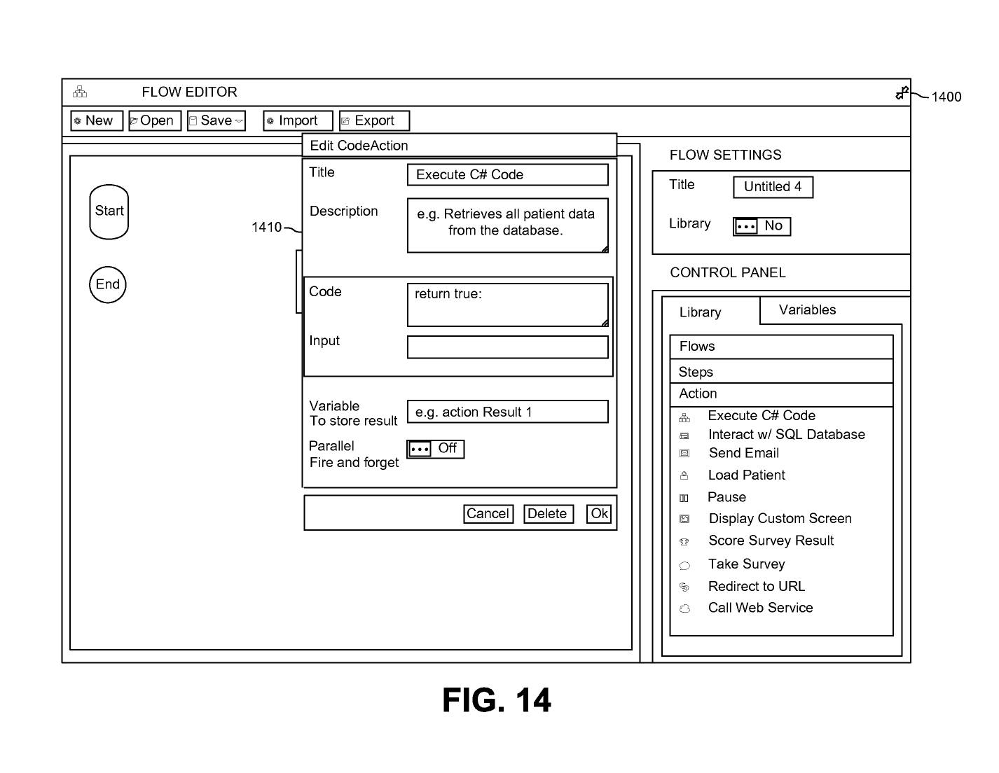

FIG. 14 illustrates an example interface 1400 for configuring a code action in a workflow step. The interface includes an edit code action block 1410. The information entered in the the edit code action block 1410 can define the action in a respective configuration file for the logic flow. In the example of FIG. 14, the edit action block can be employed to specify a title for the code action (e.g., execute a C# action), a description for the code action, a code statement, a input to receive data for the code action, a variable to store output from the code action, a switch to enable as a parallel or background action, for example.

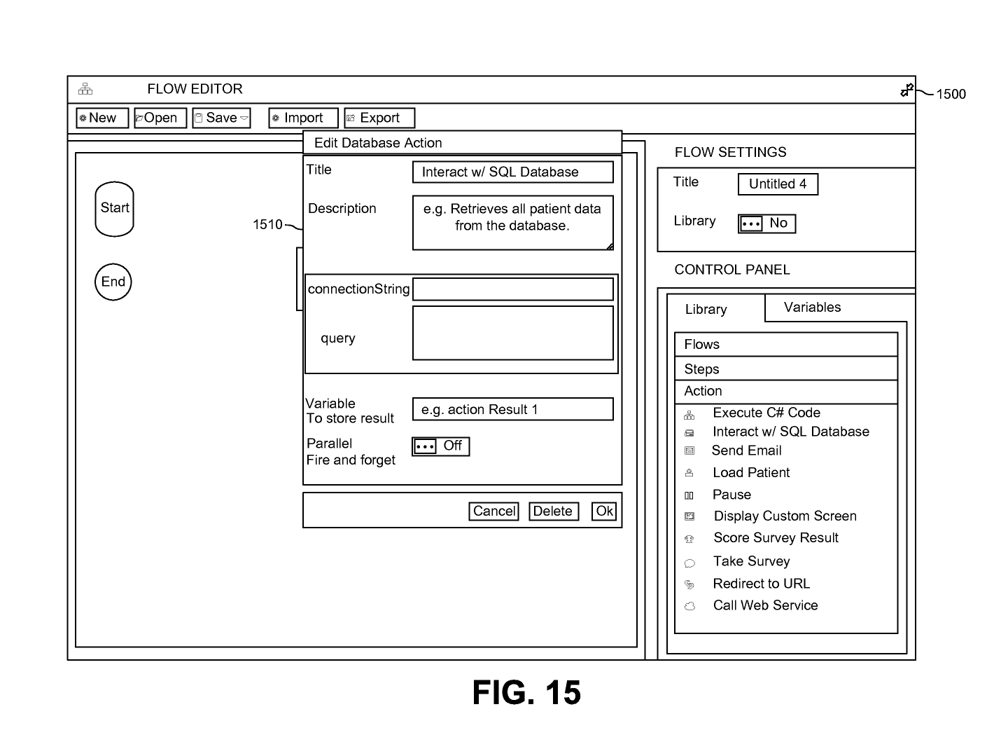

FIG. 15 illustrates an example interface 1500 for configuring a database action in a workflow step. This includes an database action block 1510 which can include a title for the database action (e.g., execute SQL database), a description for the database action, a connection string for the database action, a query to receive data for the database action, a variable to store output from the database action, and a switch to enable as a parallel or background database action for example.

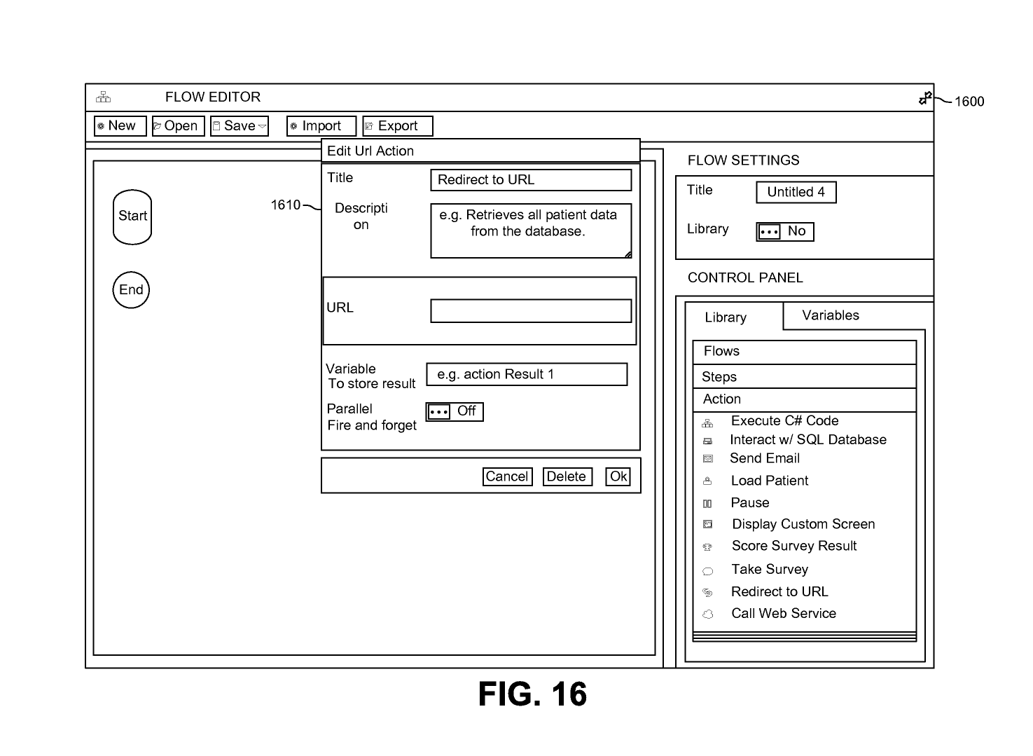

FIG. 16 illustrates an example interface 1600 for configuring a URL action in a workflow step. The interface 1600 includes a URL action block 1610 which can include a title for the URL action (e.g., redirecting to URL), a description for the URL action (e.g., receives patient data from database), a URL field representing a specific URL to interact with, a variable to store output from the URL action, and a switch to enable as a parallel or background URL action for example. Thus, an execution engine can access the resource specified at the URL and store the variable result in memory associated with the logic flow being executed.

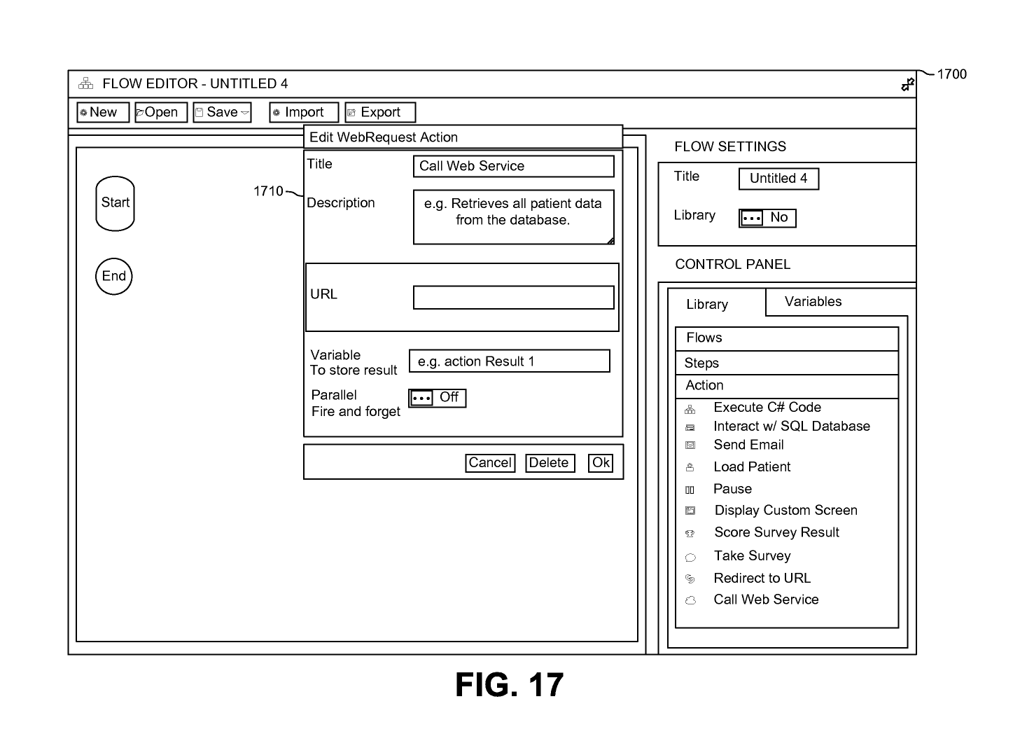

FIG. 17 illustrates an example interface 1700 for configuring a web request action in a workflow step. The interface 1700 includes a web request action block 1710 which can include a title for the web request action (e.g., call Web Service), a description for the web request action (e.g., receives patient data from database), a URL field representing a specific URL to perform the web request action, a variable to store output from the web request action, and a switch to enable as a parallel or background web request action for example. Thus, an execution engine can access the resource specified at the URL for the corresponding web service and store each variable that is returned by the web service as a corresponding result in memory associated with the logic flow being executed.

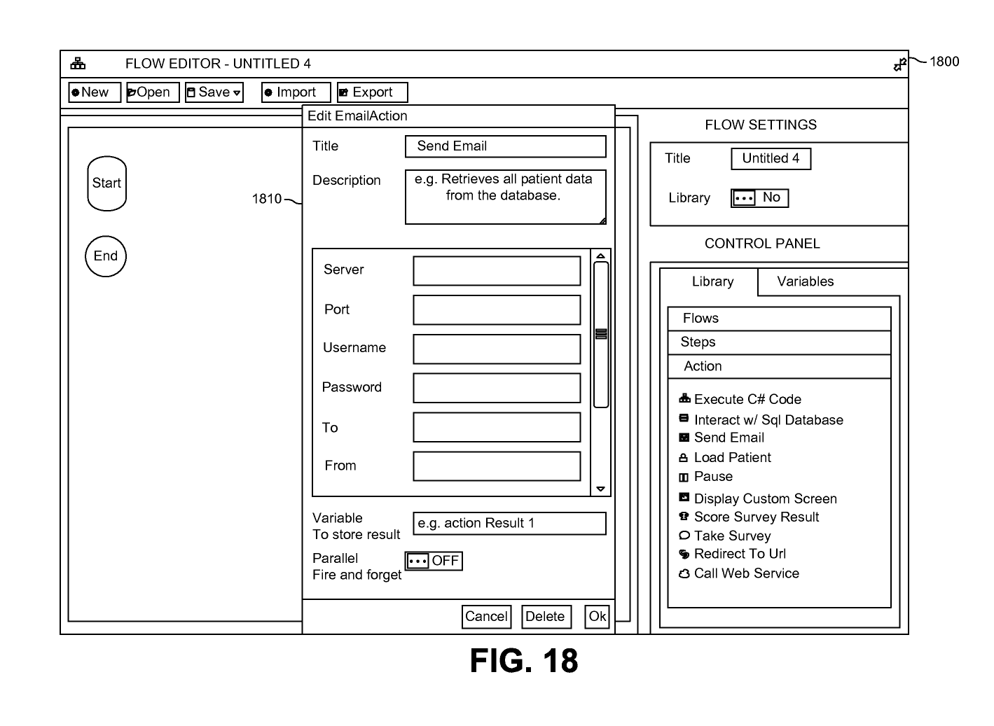

FIG. 18 illustrates an example interface 1800 for configuring an e-mail action in a workflow step. The interface 1800 includes an e-mail action block 1810 that specifies parameters and metadata associated with the action. The which can include a title for the e-mail action (e.g., send e-mail) and a description for the e-mail action (e.g., receives patient data from database). The e-mail action block can include several fields for configuring an—e-mail action, such as a server name, port address, username, password, a To: filed, a From: field, and so forth. Similar to above, the e-mail action block 1810 can also include a variable to store output from the e-mail action, and a switch to enable as a parallel or background e-mail action for example.

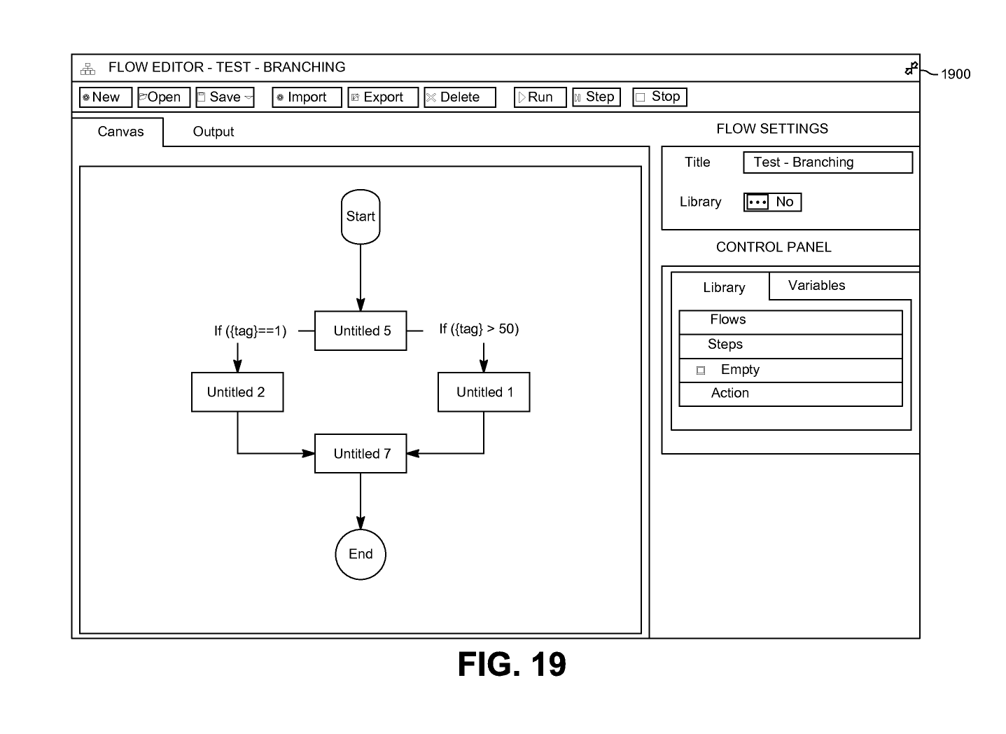

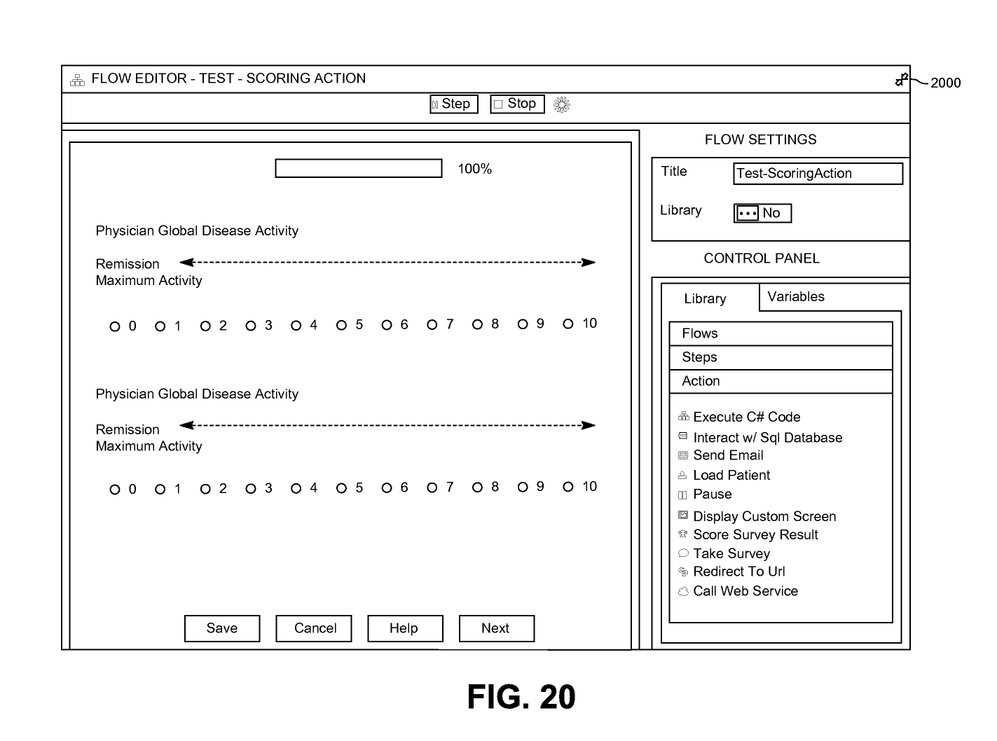

FIG. 19 illustrates an example of a graphical representation of a logic flow that can be generated by a logic flow generator. Such output logic flow can be generated as a virtual output outside of an execution engine environment to test the workflow during development of the workflow. An interface 1900 of FIG. 19 depicts a branching path through a logic flow by highlighting the steps that are activated during an execution run of the logic flow. FIG. 20 shows an example interface 2000 depicting output from a scoring action for a given logic flow within a logic flow generator GUI.

As will be appreciated by those skilled in the art, portions of the invention may be embodied as a method, data processing system, or computer program product. Accordingly, these portions of the present invention may take the form of an entirely hardware embodiment, an entirely software embodiment, or an embodiment combining software and hardware. Furthermore, portions of the invention may be a computer program product on a computer-usable storage medium having computer readable program code on the medium. Any suitable computer-readable medium may be utilized including, but not limited to, static and dynamic storage devices, hard disks, optical storage devices, and magnetic storage devices.

Certain embodiments of the invention are described herein with reference to flowchart illustrations of methods, systems, and computer program products. It will be understood that blocks of the illustrations, and combinations of blocks in the illustrations, can be implemented by computer-executable instructions. These computer-executable instructions may be provided to one or more processor of a general purpose computer, special purpose computer, or other programmable data processing apparatus (or a combination of devices and circuits) to produce a machine, such that the instructions, which execute via the processor, implement the functions specified in the block or blocks.

These computer-executable instructions may also be stored in computer-readable memory that can direct a computer or other programmable data processing apparatus to function in a particular manner, such that the instructions stored in the computer-readable memory result in an article of manufacture including instructions which implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

What have been described above are examples. It is, of course, not possible to describe every conceivable combination of components or methodologies, but one of ordinary skill in the art will recognize that many further combinations and permutations are possible. Accordingly, the disclosure is intended to embrace all such alterations, modifications, and variations that fall within the scope of this application, including the appended claims. As used herein, the term “includes” means includes but not limited to, the term “including” means including but not limited to. The term “based on” means based at least in part on. Additionally, where the disclosure or claims recite “a,” “an,” “a first,” or “another” element, or the equivalent thereof, it should be interpreted to include one or more than one such element, neither requiring nor excluding two or more such elements.

What is claimed is:

1. A system comprising:
an interface to connect and define one or more steps of a workflow, each step having at least one action to perform a task for an enterprise, wherein the one or more steps of the workflow and the at least one action to perform the task are defined as an abstraction layer to select preprogrammed instruction code blocks to implement the action; and
a logic flow generator to process the workflow from the interface to generate a configuration file that defines executable actions representing the workflow from the selected instruction code blocks specified by the abstraction layer.

2. The system of claim 1, further comprising a library to store the instruction code blocks to define the at least one action in the abstraction layer.

3. The system of claim 2, wherein the library includes at least one of a logic flow defining one or more steps and actions, other code modules that include custom code, or another library of enterprise-related actions or workflows to perform the task.

4. The system of claim 1, further comprising at least one of an internal network connection and a public network connection to execute the interface.

5. The system of claim 1, wherein the step is defined via the abstraction layer and includes at least one of a static variable, data from a previous step, external data retrieved by the step, a code block for processing within the step, an action, and logic to evaluate results of the step.

6. The system of claim 5, wherein the configuration file includes an identifier to access the instruction code block for each step in a workflow and associated connections to control transitions between each step.

7. The system of claim 6, wherein the connections represent a direct transition to another step or a decision branch that includes conditional logic to control conditions required to transition from a given step to at least one other step.

8. The system of claim 6, wherein the each step in the configuration file includes at least two of a title, a step location, a color, a step description, an action, and an action parameter.

9. The system of claim 1, wherein the workflow invokes actions representing questions forms that are processed by the enterprise.

10. The system of claim 9, wherein each of the question forms defines an individual logic flow of the workflow and each individual logic flow includes a set of individual questions stored as respective actions of the individual questions in a library.

11. The system of claim 10, wherein the configuration file defines a scoring action to score answers to the individual questions.

12. The system of claim 1, further comprising an execution engine to execute the instruction code blocks specified in the configuration file or from a library storing the instruction code blocks.

13. A method comprising:
selecting, by a processor, one or more steps from a library in response to a user input;
selecting, by the processor, one or more actions for each step in response to another user input, wherein the one or more steps and the one or more actions are defined as an abstraction layer specifying executable instruction code blocks to implement the action;
connecting, by the processor, each step to form a workflow for an enterprise in response to a user input, each connection specifying a source action and a destination action to traverse in the workflow; and
generating, by the processor, a configuration file representing the workflow, the configuration file defining an abstraction layer for the arrangement of actions and associated connections.

14. The method of claim 13, further comprising executing the configuration file to perform the workflow from the selected code blocks of the abstraction layer.

15. The method of claim 13, further comprising executing the instruction code blocks from the configuration file or from a library that stores the executable instruction code blocks.

16. The method of claim 13, further comprising generating a logic flow defining one or more steps and actions in the workflow.

17. The method of claim 13, further comprising generating and populating a questionnaire via the workflow.

18. A system comprising:
a configuration file that defines a sequence of discrete executable actions and associated connections between each pair of sequential actions to represent an ordered workflow, wherein the workflow includes one or more steps, each step including at least one action to perform a task for an enterprise, the one or more steps of the workflow and the at least one action to perform the task are defined in an abstraction layer to select preprogrammed instruction code blocks to implement each action; and
an execution engine to interpret the workflow provided by the configuration file to perform the task for the enterprise by invoking each of the selected code blocks identified in the abstraction layer and in an ordered sequence represented by the workflow.

19. The system of claim 18, wherein the configuration file includes an identifier to access the instruction code block for each step in the workflow and the connections to control transitions between each step.

20. The system of claim 18, further comprising a library to store the executable instruction code blocks specified by the configuration file.

21. The system of claim 18, wherein the step is defined via the abstraction layer and includes at least one of a static variable, data from a previous step, external data retrieved by the step, a code block for processing within the step, an action, and logic to evaluate the step.
